(19) United States
(12) Patent Application Publication
(10) Pub. No.: US 2017/0194753 A1
(43) Pub. Date: Jul. 6, 2017

(54) USB TYPE-C CONNECTOR AND METHOD FOR MANUFACTURING THE SAME

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventors: Chenguo WANG, Beijing (CN); Xiangxin Huang, Beijing (CN); Chao Gao, Beijing (CN); Fanbo Kong, Beijing (CN)

(21) Appl. No.: 15/242,282

(22) Filed: Aug. 19, 2016

Related U.S. Application Data
(63) Continuation of application No. PCT/CN2016/088777, filed on Jul. 6, 2016.

(30) Foreign Application Priority Data
Dec. 31, 2015 (CN) 2015110317900

(51) Int. Cl. H01R 24/60; H01R 13/516

(52) U.S. Cl. CPC H01R 24/60; H01R 13/516; H01R 2107/00

(57) ABSTRACT

The present application relates to a Universal Serial Bus (USB) Type-C connector and a method of manufacturing the same. Such a USB Type-C connector comprises a casing, an insulating body, a first conductive terminal strip and a second conductive terminal strip, wherein the said casing is configured on the said insulating body, the said first conductive terminal strip and the said second conductive terminal strip are spaced apart and configured to be facing each other inside the said insulating body.

### CROSS REFERENCE TO RELATED APPLICATIONS

The present application is a continuation of PCT application which has an application number of PCT/CN2016/088777 and was filed on Jul. 6, 2016. The present application claims the priority of a Chinese patent application titled “A USB TYPE-C CONNECTOR AND METHOD FOR MANUFACTURING THE SAME”, which was filed with the Chinese Patent Office on Dec. 31, 2015 and has an application number of 2015110317900, the contents of which are incorporated by reference herein in its entirety.

### TECHNICAL FIELD

The present application relates to the technological field of electronics, a Universal Serial Bus (USB) Type-C connector and a method of manufacturing the same in particular.

### BACKGROUND

Type-C is an interface of a USB connector which can be plugged without regard to plug orientation. Given the USB Standard, it supports same as other interfaces, power charging, data transmission, display output and so forth.

Type-C connectors found in prior art typically consist of an upper insertion assembly, a bottom insertion assembly, a middle isolation plate and a casing, where an insulation metal sheet for signal shielding is configured within the middle isolation plate. This type of Type-C connectors of such a structure is typically fastened by using a double-piece snap-fit assembly and then performing a second forming process, or by directly using two double-piece snap-fit assemblies. Current Type-C connectors are composed of multiple components, the structures and shapes of which are different, thus, components are not able to be used interchangeably. Furthermore, a metallic isolation sheet is configured within the middle isolation plate. Components are consequently manufactured by separate molding, assembling, and second forming. Such manufacturing process is rather complicated.

### SUMMARY

Having considered the above problems, the present invention aims to provide a USB Type-C connector in which a first conductive terminal strip, a second conductive terminal strip and an insulating body can be manufactured by a single injection molding process.

In one aspect of the present invention, it provides a USB Type-C connector, comprising a casing, an insulating body, a first conductive terminal strip and a second conductive terminal strip, wherein the said casing is configured on the said insulating body, the said first conductive terminal strip and the said second conductive terminal strip are spaced apart and configured to be facing each other inside the said insulating body.

Furthermore, a first installation slot and a second installation slot, extending along the said insulating body in forward and backward directions, are formed within the said insulating body, and the said first conductive terminal strip and the said second conductive terminal strip are respectively configured in the said first installation slot and the said second installation slot.

Furthermore, a casing securing structure which is used to hold the said casing in position is configured at a rear end of the insulating body.

Furthermore, the casing securing structure comprises an engaging surface and a positioning block, the said engaging surface is formed on the surface of the said insulating body, and the said positioning block is on the said engaging surface.

Furthermore, a space for coupling is formed between the said casing and the said first and second conductive terminal strips in order to be capable of being plugged into correspondingly matched interfacing slots.

Furthermore, the said casing is made of metallic materials.

Furthermore, terminals on the said first and second conductive terminal strips are made of copper materials.

Furthermore, the said insulating body is made of plastic.

In a second aspect of the present invention, it provides a data cable which comprises the said USB Type-C connector.

In a third aspect of the present invention, it provides a method of manufacturing the said USB Type-C connector comprising steps as follows.

(S1) Placing a first conductive terminal strip and a second conductive terminal strip in a mould, provided that there is a space between the two trips;

(S2) Injecting melted insulating materials into the mould to form an insulating body, so as to form an integral structure consisting the first conductive terminal strip, the second conductive terminal strip and the said insulating body; and

(S3) Installing a casing onto the said insulating body.

The USB Type-C connector provided in the present invention does not need to configure an insulation metallic sheet for signal shielding within the middle isolation plate, but adopts an integral forming technique that injection molds a first conductive terminal strip, a second conductive terminal strip and an insulating body of the USB Type-C connector in one time, and installing a casing after the injection molding. The production process is simple, streamlining the production technique process and reducing the production cost.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG.1 is an illustrative structural view of a USB Type-C connector in accordance with the present embodiment;

FIG.2 is a sectional view of a USB Type-C connector in accordance with the present embodiment; and

FIG.3 is an illustrative view of distribution of terminals on a first conductive terminal strip and a second conductive terminal strip of a USB Type-C connector in accordance with the present embodiment.

### PREFERABLE EMBODIMENT OF THE INVENTION

Embodiments of the present invention are to be further elaborated in detail with reference to the accompanying figures. The drawings illustrate example embodiments of the present disclosure; it should be appreciated, however, that implementation of the present invention may be achieved through various forms and should not be limited, in any way, by the embodiments provided. To the contrary, the embodiments are provided for better understanding of the present invention and fully conveying the entire scope of the present disclosure to those skilled in the art.

Note that, according to the present invention, when a USB Type-C connector in operation is placed horizontally, one end facing towards the device into which is plugged refers to a front end, and the other opposite end refers to a rear end.

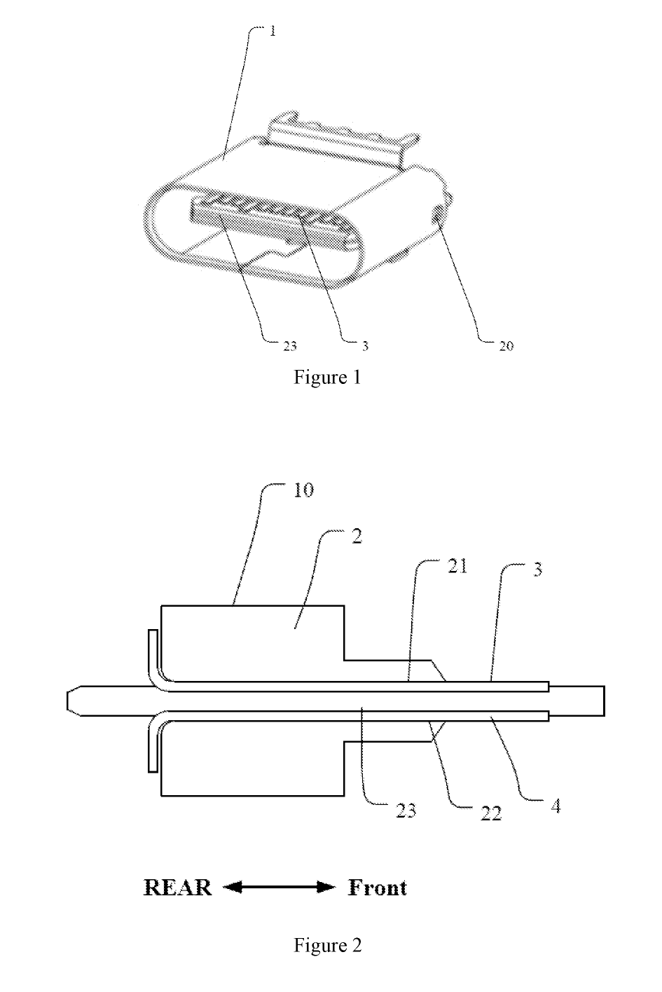

FIGS. 1-2 respectively show an illustrative structural view and a sectional view of a USB Type-C connector in accordance with the present embodiment. The said USB Type-C connector is a structure for connecting a data cable, comprising a casing 1, an insulating body 2, a first conductive terminal strip 3 and a second conductive terminal strip 4, wherein the said casing 1 is configured on the said insulating body 2, the said first conductive terminal strip 3 and the said second conductive terminal strip 4 are spaced apart and configured to be facing each other inside the said insulating body 2. The said casing 1 is made of metallic materials, shielding the said USB Type-C connector. The insulating body is of an integral structure made from insulating materials such as plastics and so forth, wherein, for example, an integral structure is made by injection molding.

A first installation slot 21 and a second installation slot 22, extending along the said insulating body 2 in forward and backward directions, are formed within the said insulating body 2. Shapes and sizes of the said first installation slot 21 and the said second installation slot 22 match those of the said first conductive terminal strip 3 and the said second conductive terminal strip 4, and the said first installation slot 21 and the said second installation slot 22 are respectively used for fixing the said first conductive terminal strip 3 and the said second conductive terminal strip 4. The said first conductive terminal strip 3 and the said second conductive terminal strip 4 are respectively configured in the said first installation slot 21 and the said second installation slot 22. The said insulating body 2 between the said first conductive terminal strip 3 and the said second conductive terminal strip 4 forms a separating portion 23. Conductive terminals on the said first conductive terminal strip 3 and the said second conductive terminal strip 4 are fitted into the said separating portion 23 so as to secure and support every one of the said conductive terminals.

A casing securing structure which is used to fix the said casing 1 in position is configured at a rear end of the insulating body 2. The casing securing structure comprises an engaging surface 10 and a positioning block 20, the said engaging surface 10 is formed on the surface of the said insulating body 2, and the said positioning block 20 is on the said engaging surface 10. The said positioning block 20 can be several protrusions spaced apart. When the casing is fitted onto the said engaging surface 10 following passing the said positioning block 20, that the said casing 1 drops from the said insulating body 2 can be prevented.

A space for coupling is formed between the said casing 1 and the said first conductive terminal strip 3 and the said second conductive terminal strip 4 in order to be capable of being plugged into a correspondingly matched interfacing slot.

The said first conductive terminal strip 3 and the said second conductive terminal strip 4 can be made of metallic materials of good conductivity, for example that it can be made by stamping from a copper strip.

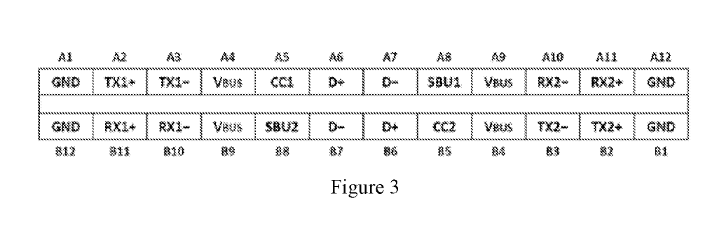

FIG. 3 shows the structures of the said first conductive terminal strip 3 and the said second conductive terminal strip 4 in the present embodiment. A1-A12 conductive terminals are configured on the said first conductive terminal strip 3; B1-B12 conductive terminals are configured on the said second conductive terminal strip 4. The said first conductive terminal strip 3 and the said second conductive terminal strip 4 both comprise terminals comprising positive power terminals, negative power terminals, positive data terminals and negative data terminals, so that it provides the USB Type-C connector of the present embodiment with the functions of power charging and data transmission.

The method of manufacturing a USB Type-C connector according to the present embodiment comprises the following steps:

(S1) Placing a first conductive terminal strip 3 and a second conductive terminal strip 4 in a mould, provided that there is a space between the two trips;

(S2) Injecting melted insulating materials under a certain temperature into the mould, forming an insulating body after pressure maintaining and cooling, so as to make the first conductive terminal strip 3, the second conductive terminal strip 4 and the insulating body 2 into an integral part, a process preferred for this step is injection molding; and

(S3) Installing the casing 1 onto the said insulating body 2 to form an integral structure of USB Type-C connector.

The above method of manufacturing is particularly applicable to USB Type-C connectors working under a condition of low signal transmission rate, where no insulation metallic sheet for signal shielding is required in the middle isolation plate e.g. USB2.0.

On the basis of the above methods of manufacturing, the first conductive terminal strip, the second conductive terminal strip and the insulating body of a USB Type-C connector can be molded in one time, and only a casing is to be put in place after completion of the injection molding. Such manufacturing process is simple, streamlining the manufacturing process and bringing down the production cost.

It should be understood that, in this specification, terms like “first”, “second” and the like are only used to distinguish one entity or operation from another, but are not necessarily to require or imply any practical relationship or order between these entities or operations. Moreover, a term such as “comprise”, “include” or any variations of the term shall be construed as “including but not limited to”. Therefore, any process, method, object, or device that includes a series of elements not only includes these elements, but also includes other elements that are not specified expressly, or may further include inherent elements of the process, method, object or device. In case there is no further limitation, in the context of one element that is specified by “include one . . . ”, the process, method, object or device that includes a specified element may include other identical elements. Lastly, it should be understood that the above embodiments are examples made merely for clear elaboration of the present invention, none of those intends to limit the scope of the present application. Those skilled in the art appreciate that the present application may be modified and has variations. Any modifications, equivalent substitutes and improvements within the spirit and principles of the present application all fall within the protection scope of the present invention.

1-10. (canceled)

11. A USB Type-C connector comprising: a casing, an insulating body, a first conductive terminal strip and a second conductive terminal strip, wherein the said casing is configured on the said insulating body, the said first conductive terminal strip and the said second conductive terminal strip are spaced apart and configured to be facing each other inside the said insulating body.

12. The USB Type-C connector according to claim 11, wherein a first installation slot and a second installation slot, extending along the said insulating body in forward and backward directions, are formed within the said insulating body, and the said first conductive terminal strip and the said second conductive terminal strip are respectively configured in the said first installation slot and the said second installation slot.

13. The USB Type-C connector according to claim 11, wherein a casing securing structure which is used to secure the said casing in position is configured at a rear end of the insulating body.

14. The USB Type-C connector according to claim 13, wherein the casing securing structure comprises an engaging surface and a positioning block, the said engaging surface is formed on the surface of the said insulating body, and the said positioning block is on the said engaging surface.

15. The USB Type-C connector according to claim 11, wherein a space for coupling is formed between the said casing and the said first and second conductive terminal strips in order to be capable of being plugged into a correspondingly matched interfacing slot.

16. The USB Type-C connector according to claim 11, wherein the said casing is made of metallic materials.

17. The USB Type-C connector according to claim 11, wherein terminals on the said first and second conductive terminal strips are made of copper materials.

18. The USB Type-C connector according to claim 11, wherein the said insulating body is made of plastic.

19. A data cable, comprising: a USB Type-C connector, wherein the said USB Type-C connector comprises a casing, an insulating body, a first conductive terminal strip and a second conductive terminal strip, the said casing is configured on the said insulating body, the said first conductive terminal strip and the said second conductive terminal strip are spaced apart and configured to be facing each other inside the said insulating body.

20. The data cable according to claim 9, wherein a first installation slot and a second installation slot, extending along the said insulating body in forward and backward directions, are formed within the said insulating body, and the said first conductive terminal strip and the said second conductive terminal strip are respectively configured in the said first installation slot and the said second installation slot.

21. The data cable according to claim 19, wherein a casing securing structure which is used to secure the said casing in position is configured at a rear end of the insulating body.

22. The data cable according to claim 21, wherein the casing securing structure comprises an engaging surface and a positioning block, the said engaging surface is formed on the surface of the said insulating body, and the said positioning block is on the said engaging surface.

23. The data cable according to claim 19, wherein a space for coupling is formed between the said casing and the said first and second conductive terminal strips in order to be capable of being plugged into a correspondingly matched interfacing slot.

24. The data cable according to claim 19, wherein the said casing is made of metallic materials.

25. The data cable according to claim 19, wherein terminals on the said first and second conductive terminal strips are made of copper materials.

26. The data cable according to claim 19, wherein the said insulating body is made of plastic.

27. A method for manufacturing the USB Type-C connector according to claim 1, comprising the following steps:
(S1) placing a first conductive terminal strip and a second conductive terminal strip in a mould, provided that there is a space between the two trips;
(S2) injecting melted insulating materials into the mould to form an insulating body, so as to form an integral structure consisting the first conductive terminal strip, the second conductive terminal strip and the said insulating body; and
(S3) installing a casing onto the said insulating body.
